(19) United States
(12) Patent Application Publication
(10) Pub. No.: US 2004/0236019 A1
(43) Pub. Date: Nov. 25, 2004

(54) Coloured paint for the screen printing of the inner side of insert-moulding pieces

(76) Inventors: Uwe Numrich, Gross-Zimmem (DE); Michael Enders, Dieburg (DE); Lothar Kruska, Griesheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/486,202

(22) PCT Filed: Aug. 13, 2002
(86) PCT No.: PCT/EP02/09055

(30) Foreign Application Priority Data
Aug. 27, 2001 (DE) 101 40 720.3
Oct. 22, 2001 (DE) 101 51 281.3

(51) Int. Cl. B32B 5/12

(52) U.S. Cl. 525/66; 428/110

(57) ABSTRACT

The invention relates to a coloured paint, suitable for the printing of films made from transparent, thermoplastic plastics, essentially comprising: a) one or more pigments, b) a binding agent, dissolved in c) an organic solvent or a mixture of organic solvents and d) usual adjuncts, characterised in that a poly(meth)acrylate or a poly(meth)acrylimide compound is used as binding agent with a vicat softening temperature VET (ISO 306 B) of at least 115° C. The invention further relates to printed films and insert-moulding pieces, produced using the above paint and the corresponding method for production and uses of the said insert-moulding pieces.

The invention relates to a paint suitable for printing the inside of insert moldings, consisting essentially of one or more pigments, optionally customary auxiliaries, and a binder dissolved in an organic solvent or in a mixture of organic solvents.

### PRIOR ART

Screen printing inks and screen printing paints find broad application. For example, films of transparent plastics can be printed on their reverse side with screen printing inks. The printed films are subsequently shaped and backmolded on their reverse face in an injection mold (insert molding). A wide variety of plastics parts, such as differently printed or colored, exchangeable cases for cell phones, for example, can be produced thereon. The requirements imposed on the quality of the screen print are stringent, since in the injection backmolding operation it is required to be resistant to temperatures in the region of 260° C. and pressures of around 1000 bar and ought not to deteriorate in terms of the printed image over the course of the period of use.

DE 44 21 561 A1 describes flexible, high-temperature-resistant screen printing inks. Disclosed as binders for the pigments are thermoplastic, aromatic polycarbonate polymers dissolved in customary solvents. Using an exemplary coating formulation it is possible to obtain high-contrast printed color patterns. Conversely, the printed color patterns obtained with a polyacrylate binder are blurred.

### PROBLEM AND SOLUTION

It has been found that screen printing inks and screen printing paints based on polycarbonate compounds, which for the rear-side printing of films which are processed to insert moldings in a subsequent injection backmolding operation are not always stable with respect to the injection backmolding operation, also have a greater or lesser tendency to yellow over time and in accordance with the stresses on them.

It was seen as an object to provide a paint suitable for screen printing the inside of insert moldings which is comparatively stable with respect to the injection backmolding operation, in terms of its printed imagine, and which exhibits extremely high color fastness even after prolonged weathering.

This object is achieved by means of

a paint suitable for printing films of transparent thermoplastic, especially for printing films used for insert moldings, consisting essentially of

a) one or more pigments,

b) a binder in solution in

c) an organic solvent or a mixture of organic solvents

d) customary auxiliaries if desired,

characterized in that

use is made as binder of a poly(meth)acrylate or poly(meth)acrylimide compound which has a Vicat softening temperature VST (ISO 306 B) of at least 115° C.

Implementation of the Invention

Paint

The paint is composed of

a) one or more pigments, preferably in an amount of from 10 to 50% by weight

b) a binder, preferably in an amount of from 10 to 50% by weight, in solution in

c) an organic solvent or a mixture of organic solvents, and

d) if desired, customary auxiliaries, preferably in an amount up to 10% by weight, in particular from 0.1 to 10% by weight,

the amounts being based on the liquid paint

Pigments

The paint contains pigments, preferably in an amount of from 10 to 50%, more preferably from 15 to 30% by weight based on the liquid paint.

Examples of suitable pigments include carbon blacks, titanium dioxide, metal pigments, red iron oxide or red iron oxide grades, cobalt pigments, e.g., cobalt blue grades, cobalt green grades, and organic pigments.

Binder

The paint comprises a binder, in particular a polymeric binder, preferably in an amount of from 10 to 50%, in particular from 15 to 35% by weight based on the liquid paint.

As binders it is possible to use poly(meth)acrylate or poly(meth)acrylimide compound which have a Vicat softening temperature VST (ISO 306 B) of at least 115° C., e.g., of from 115 to 180° C., preferably at least 118° C., e.g., of from 118 to 125° C., more preferably at least 125° C., in particular at least 130° C., e.g., from 140 to 180° C. or from 145 to 160° C. The binders stated are very stable to temperature and also to weathering and are therefore essential to the properties of the paint system.

It is possible to use a poly(meth)acrylate compound which is a polymer of

(m1) from 50 to 90% by weight of alkyl methacrylate having 1 to 6 carbon atoms in the ester radical,

(m2) from 5 to 25% by weight of at least one vinyl aromatic,

(m3) from 1 to 25% by weight of maleic anhydride, and if desired

(m4) from 0 to 5% by weight of alkyl acrylate having 1 to 6 carbon atoms in the ester radical

The monomers (m1), (m2), (m3) and (m4):

The monomers (m1), used at from 50 to 90% by weight based on the overall monomers, are selected from the group of alkyl methacrylates having 1 to 6 carbon atoms in the ester radicals, such as ethyl methacrylate, propyl methacrylate, isopropyl methacrylate, butyl methacrylate, isobutyl methacrylate, tert-butyl methacrylate, pentyl methacrylate, isopentyl methacrylate, hexyl methacrylate, 2,2-dimethylbutyl methacrylate, cyclopentyl methacrylate, cyclohexyl methacrylate, and, with particular preference, methyl methacrylate, for example.

The monomers (m2) are selected from the group of vinylaromatics, such as -halostyrene, p-methylstyrene, p-tert-butylstyrene, vinylnaphthalene, and preferably α-methylstyrene and, with particular preference, styrene.

The monomer maleic anhydride (m3) is used with a purity of at least 95%, preferably of at least 99%. In order to convert the maleic anhydride into the liquid aggregate state it is heated above its melting point of 52.85° C., preferably to temperatures of between 55 and 80° C., more preferably between 60 and 80° C. At the temperatures indicated above the liquid maleic anhydride can be stored under an inert gas atmosphere for a number of weeks.

The alkyl acrylates (m4) can be incorporated in fractions of up to 5% by weight in order to enhance the rheological properties of the terpolymers TP. Example of alkyl acrylates having 1 to 6 carbon atoms in the ester radical are ethyl acrylate, isopropyl acrylate, propyl acrylate, isobutyl acrylate, tert-butyl acrylate, pentyl acrylate, hexyl acrylate, and preferably butyl acrylate and, with particular preference, methyl acrylate.

The monomers (m1), (m2), and (m4) and mixtures thereof are liquid under the mixing conditions.

Corresponding copolymers can be obtained in conventional manner by free-radical polymerization. EP-A 264590 describes, for example, a process for producing a molding compound from a monomer mixture comprising methyl methacrylate, vinylaromatic, maleic anhydride, and, if desired, a lower alkyl acrylate, the polymerization being conducted up to to a conversion of 50% in the presence or absence of a nonpolymerizable organic solvent and the polymerization being continued, above a conversion of at least 50%, in the temperature range from 75 to 150° C. in the presence of an organic solvent, up to a conversion of at least 80%, and then evaporating the low molecular mass, volatile constituents.

JP-A 60-147 417 describes a process for producing a polymethacrylate molding compound of high heat distortion resistance, in which a monomer mixture of methyl methacrylate, maleic anhydride, and at least one vinylaromatic is fed at a temperature of from 100 to 180° C. into a polymerization reactor suitable for solution polymerization or bulk polymerization and is polymerized. DE-A 44 40 219 describes a further production process.

Suitable binders include those poly(meth)acrylate compounds which are composed, for example, of from 90 to 100% by weight of methyl methacrylate units and which owing to a particular preparation process achieve Vicat softening temperatures VST (ISO 306 B) of at least 115° C., preferably from 116 to 122° C. EP-A 245 647 describes, for example, a process for producing poly(meth)acrylate molding compounds by means of emulsion polymerization at polymerization temperatures of from 0 to 100° C., e.g., from 20 to 90° C., in the presence of an initiator-regulator ratio of at least 1:2, preferably 1:5 or above. The poly(meth)acrylate molding compounds thus obtained have a tacticity fraction of syndiotactic triades of more than 60%, while the isotactic fraction is preferably less than 5%. The TD values of the molding compounds (2% depolymerization at a heating rate of 5° C./min) are preferably at least 290° C. The Vicat softening temperatures VST (ISO 306 B) are situated in the range from 115 to 122° C. Correspondingly prepared polymers may be composed of from 90 to 100% by weight of methyl methacrylate units. In proportions of from 0 to 10%, preferably from 0 to 5%, in particular from 0 to 2% by weight it is possible where appropriate for free-radically polymerizable comonomers to be present, such as methyl acrylate, ethyl acrylate, methacrylonitrile, maleic acid, maleic anhydride, methacrylic esters or methacrylic amides, styrene, p-methylstyrene, vinyl esters or vinyl amides, for example.

A further preparation process for poly(meth)acrylate compounds which are composed, for example, of from 90 to 100% by weight of methyl methacrylate units and achieve Vicat softening temperatures VST (ISO 306 B) of at least 115° C. is that known as “anionic polymerization” in the presence of catalyst complexes (see, for example, Elias, H. G. (1996): Polymere; Von Monomeren und Makromolekülen zu Werkstoffen, Huthig & Wepf Verlag). The process, however, is very complex, and so to date has played virtually no part in practice.

As binder it is additionally possible to use poly(meth)acrylimide compound obtained from a partial or complete imidation of polymers of alkyl esters of methacrylic acid by reaction with an imidating agent (see, for example, EP-A 441 148 or EP-A 666 161). Preference is given to poly(meth)acrylimide compounds having a degree of imidation (glutarimide content) of from 50 to 100%, preferably from 60 to 95%, in particular from 65 to 80% by weight. At degrees of imidation below 100% the poly(meth)acrylimide compounds generally include, as byproducts of the imidation process, further comonomers such as methacrylic acid and methacrylic anhydride in amounts, for example, of in each case from 1 to 15% by weight.

Preparation processes for the stated polymethacrylimides are known from EP-A 216 505, EP-A 666 161 or from EP-A 776 910.

Solvents

Suitable solvents are halogenated or, preferably, halogen-free aliphatic, cycloaliphatic, and aromatic hydrocarbons, ketones, esters, ethers, alcohols or phenols in which the stated binders dissolve readily.

Examples of suitable solvents include toluene, xylene, tetrahydrofuran, ketones, such as acetone, methyl isobutyl ketone, isophorone, butanone, methyl ethyl ketone esters, such as methyl acetate, ethyl acetate, butyl acetate, butyl propionate, methoxypropyl acetate, alcohols such as methanol, ethanol or isopropanol, and halogenated hydrocarbons such chloroform, methylene chloride, and chlorobenzene.

Suitability is possessed, for example, by mixtures of methyl ethyl ketone and alcohols, e.g., ethanol, isopropanol and/or butanol.

Preference is given to mixtures of xylene, methyl ethyl ketone, butyl acetate, ethyoxylated alcohols, e.g., ethoxy-butanol, and/or methoxybutyl acetate (Butoxyl®), it being possible for the mixture to include, where appropriate, minor fractions of solvent naphtha (industrial-grade benzene or heavy benzene, mixtures of from 50 to 70% cumene, from 30 to 30 xylene, and from 2 to 7% naphthalene oil.

Particular preference is given to mixtures of from two to three parts by weight of xylene, about one parts by weight of methyl ethyl ketone, about one parts by weight of butyl acetate, about one part by weight of an ethyoxyl alcohol, e.g., ethoxy-butanol, and one part by weight of methoxybutyl acetate (Butoxyl®) and about half a part by weight of solvent naphtha (industrial-grade benzene or heavy benzene, mixture of Chemical Abstracts. 60% cumene, 35% xylene, and 5% naphthalene oil)

Auxiliaries

The paint may where appropriate include customary auxiliaries, preferably in an amount of up to 15% by weight, in particular from 0.1 to 10% by weight. Examples of customary auxiliaries used in paints include levering assistants or UV stabilizers and/or UV absorbers, fillers if desired, wetting agents, and preservatives.

An improved weathering stability of the coating of the invention is achieved by means of incorporated UV stabilizers, such as are known as additions to polymers and are listed in Ullmanns Enzyklopadie der technischen Chemie, 4th Edition, Volume 15, pages 253 to 260, and/or advantageously by means of polymerizable UV stabilizers. As an example of polymerizable UV stabilizers mention may be made of 3-(2-benzotriazolyl)-2-hydroxy-5-tert-octylbenzylmethacrylamide. UV absorbers can be present, for examples, in amounts of from 0.1 to 10% by weight, based on the paint solids.

Insert Molding/Process

In the insert molding process films of transparent and translucent polymers printed on their reverse side with screen printing inks are used. The printed films are shaped and, in an injection molding unit, are reinforced on their reverse side by injection backmolding with thermoplastics, to give relatively thick insert moldings.

Films

Films which are suitable for reverse-side printing may be composed, for example, of thermoplastics, preferably transparent thermoplastics such as polystyrene, polycarbonate, polyethylene terephthalate or polymethyl methacrylate, for example, preferably of impact-modified polymethyl methacrylate. Suitability is possessed, for example, by poly(meth)acrylates composed of from 80 to 99.9% by weight of methyl methacrylate and of from 0.1 to 20% by weight of further comonomers. Examples of suitable comonomers include esters of methacrylic acid (e.g., ethyl methacrylate, butyl methacrylate, hexyl methacrylate, cyclohexyl methacrylate), esters of acrylic acid (e.g., methyl acrylate, ethyl acrylate, butyl acrylate, hexyl acrylate, cyclohexyl acrylate) or styrene and styrene derivatives, such as α-methylstyrene or p-methylstyrene, for example.

Impact-modifiers for polymethacrylate polymers are sufficiently well known. As impact-modifiers for the poly(meth)acrylates it is possible to use crosslinked single-shell or multishell emulsion-polymers composed, for example, of crosslinked polybutyl acetate. Production and structure of impact-modified polymethacrylate molding compounds are described, for example, in EP-A 0 113 924, EP-A 0 522 351, EP-A 0 465 049 and EP-A 0 683 028.

The film thickness can amount, for example, to from 10 to 500 μm, preferably from 50 to 300 μm. The printed film is an intermediate for the corresponding insert moldings.

Printing Operation

The films are printed in conventional manner in a screen printing process (see, for example: E. Schulz: Ein lehrreiches Fachseminar in Stuttgart: Bedrucken von Kunststoffen, Verpackungs-Rundschau 11/1985, pp. 1262-1270 or W. Krause: “Siebdruck auf Kunststoffen, Entwicklungstendenzen”, Plastverarbeiter, No. 9, 1981, pp. 1249-1251).

Injection Backnolding Operation/Process

The process for producing insert moldings includes the following steps,

a. Printing of a film of a thermoplastic in a screen printing process with a paint,

b. Shaping of the film, e.g., with the high pressure forming process. In this process the film is fixed in a holder, e.g., a holding-down device, and shaped at a temperature which can be situated between room temperature, i.e., from about 20° C., to below the Vicat softening temperature (VST as specified in ISO 306 method B), under pressure, by means for example of compressed air at, for example, from 50 to 300 bar. A process of this kind is known, for example, from EP-A 0 371 425.

c. Injection backmolding of the printed film on the printed side in an injection mold with a thermoplastic, and

d. Removal of the insert molding from the mold.

The printed films are placed in an injection mold so that the printing is facing the nozzle side, and are injection backmolded with a thermoplastic in a layer with a thickness of, for example, from 0.5 to 10 mm, preferably from 0.5 to 2 mm. Use may be made, for example, of a hot runner mold with needle valve gate. Examples of thermoplastics suitable for injection backmolding include polycarbonate, mixtures of polycarbonate with acrylonitrile-butadiene-styrene (ABS), ASA, and, preferably, polymethyl methacrylate.

Suitability is possessed, for example, by poly(meth)acrylates composed of from 80 to 99.9% by weight of methyl methacrylate and of from 0.1 to 20% by weight of further comonomers. Examples of suitable comonomers include esters of methacrylate acid (e.g., ethyl methacrylate, butyl methacrylate, hexyl methacrylate, cyclohexyl methacrylate), esters of acrylic acid (e.g., methyl acrylate, ethyl acrylate, butyl acrylate, hexyl acrylate, cyclohexyl acrylate) or styrene and styrene derivatives, such as α-methylstyrene or p-methylstyrene, for example.

Particular preference is given to polymethyl methacrylates which are copolymers of from 98 to 95% by weight of methyl methacrylate and from 2 to 5% by weight of methyl acrylate, having an average molecular weight (weight average; measured by TLC or determined by means of gel chromatography) in the range from 100 000 to 200 000, preferably from 100 000 to 130 000 (daltons). Of particular suitability is, for example, a molding compound which is a copolymer of 97% by weight methyl methacrylate and 3% by weight methyl acrylate and has an average molecular weight of approximately 110 000.

Suitable mold temperatures are in the range from 40 to 80° C., preferably from 55 to 65° C. The melt temperature, particularly in the case of polymethyl methacrylate copolymer, can be in the range from 220 to 300° C., preferably from 240 to 260° C. The hot runner temperature of the mold can be in the range from 220 to 300° C., preferably from 240 to 260° C. The injection rate can be varied from low to high.

Insert Moldings

Following the injection backmolding operation the finished, cooled insert molding can be removed form the mold.

An insert molding of the invention is composed of a film of a thermoplastic, preferably a transparent thermoplastic, in particular of a film of a polymethyl methacrylate copolymer, which is printed on the reverse side with the paint of the invention and provided on that side with a coating layer of a thermoplastic, which is preferably a polymethyl methacrylate, said layer having been applied in an injection backmolding operation.

Uses

The insert moldings of the invention can find numerous uses: for example, as device covers—covers, for example, for electronic devices, mobile telephones (cell phones), backlightable displays, for example, for instruments or, for example, as colored lamps, e.g., indicator lamps or rear lamps, in, for example, motor vehicles, rail vehicles or aircraft

Advantageous Effects of the Invention

The paint of the invention offers the advantage that it is stable to high pressures and temperatures during the injection backmolding operation to produce insert moldings. Furthermore, even after a prolonged period of use of the insert moldings, the printed image shows no perceptible discoloration or yellowing. The insert moldings of the invention, especially if the outer films and/or the injection backmolding coating material is a polymethyl methacrylate copolymer, are notable for high transparency and weathering stability. The insert moldings obtainable in accordance with the invention therefore meet stringent quality requirements such as are imposed, for example, for backlightable displays or lamps in the automotive or aerospace sector.

### EXAMPLES

Commercially customary films of impact-modified polymethyl methacrylate were printed on one side with different screen printing paints (paints 1 to 3) and subsequently injection backmolded on the printed side with a polymethyl methacrylate polymer and so reinforced to form insert moldings (test elements). The test elements were subsequently tested for removal of the printing by washing.

The thickness of the films used was 250 μm.

The films were injection backmolded with (MT) and without (OT) drying of the screen printing beforehand.

Paint 1 (Inventive):

Paint 1 is composed of a solvent mixture comprising

40% by volume xylene,

17% by volume methyl ethyl ketone,

17% by volume methoxybutyl acetate (Butoxyl®)

17% by volume butyl acetate and

9% by volume solvent naphtha (industrial-grade benzene or heavy benzene, mixture of approximately 60% cumene, 35% xylene, and 5% naphthalene oil),

containing, based on the wet paint, 10% by weight of carbon black pigment and 20% by weight of a binder which is a copolymer of 65 methyl methacrylate, 20% by weight styrene and 15% by weight maleic anhydride. The Vicat softening temperature of the binder, VST, as specified in ISO 306 B is in the range from 119 to 123° C.

Paint 2 (Inventive):

The composition corresponds to paint 1 with the difference that the binder present is a polymethacrylimide copolymer composed of a polymethyl methacrylate with a degree of imidation of approximately 70%. The copolymer also includes about 4 to 6% by weight methacrylic acid and about 4 to 6% by weight methacrylic anhydride as comonomers. The Vicat softening temperature of the binder, VST, as specified in ISO 306 B is in the range from 143 to 152° C.

Paint 3 (Comparative Experiment)

The composition corresponds to paint 1 with the difference that the binder used is a commercially customary polycarbonate.

Experimental Conditions:

A hot runner mold with needle valve gate was used. The cavity had dimensions of 100×100 mm with four different height steps of 1, 2, 3 and 4 mm (stepped plate).

The printed films were cut to size and placed in the mold so that the printing points in the direction of the injection nozzle.

Injection backmolding took place under the four different conditions A to D, where A represents the most stringent requirement for the stability of the screen print, and D the least stringent.

Injection backmolding took place with a molding compound composed of polymethyl methacrylate (copolymer of 97% by weight methyl methacrylate and 3% by weight methyl acrylate with an average molecular weight of approximately 110 000, measured by TLC or determined by means of gel chromatography).

| | Melt | Mold | Hot runner | |
|---|---|---|---|---|
| Experimental | temperature | temperature | temperature | Injection |
| condition | (° C.) | (° C.) | (° C.) | rate |
| A | 260 | 60 | 265 | low |
| B | 260 | 60 | 265 | high |
| C | 280 | 60 | 280 | high |
| D | 280 | 60 | 280 | low |

High injection rate=100% of the possible performance of the unit.

Low injection rate=approximately 25% of the possible performance of the unit.

The insert moldings were removed from the mold and the washout of the screen print was assessed, in each case visually, using a rating system, for removal of the printed image by washing.

Rating ++: no perceptible washout

Rating +: virtually no perceptible washout

Rating −: distinct washout

The series of experiments and their results are compiled in the table below.

| Experimental condition | A | B | C | D |
|---|---|---|---|---|
| Paint 1 (MT) | ++ | ++ | + | + |
| Paint 1 (OT) | ++ | + | + | + |
| Paint 2 (MT) | ++ | ++ | + | + |
| Paint 2 (OT) | ++ | + | + | + |
| Paint 3 (MT) | + | + | + | − |

MT=the printed films were dried at 80° C. for 30 minutes prior to the injection backmolding operation

OT=the printed films were not dried prior to the injection backmolding operation.

1. A paint, consisting essentially of
a) one or more pigments,
b) one or more binders, and
c) at least one organic solvent,
wherein at least one poly(meth)acrylate or poly(meth)acrylimide compound having a Vicat softening temperature VST (ISO 306 B) of at least 11 5° C. is present, and wherein the binder is in solution in the organic solvent.

2. The paint of claim 1, wherein the binder comprises a poly(meth)acrylate compound which is a polymer of comprising polymerized units of
(m1) from 50 to 90% by weight of at least one alkyl methacrylate having 1 to 6 carbon atoms in the ester radical,
(m2) from 5 to 25% by weight of at least one vinyl aromatic, and
(m3) from 1 to 25% by weight of maleic anhydride, and if desired.

3. The paint of claim 1, wherein the binder comprises a poly(meth)acrylate compound which is a polymer comprising polymerized units of from 90 to 100% by weight methyl methacrylate and, where appropriate.

4. The paint of claim 1, wherein the binder comprises a poly(meth)acrylimide compound obtained from a partial or complete imidation of polymers of alkyl esters of methacrylic acid by reaction with an imidating agent.

5. The paint of claim 1, wherein the solvent comprises at least one selected from the group consisting of an aliphatic hydrocarbon, a cycloaliphatic hydrocarbon, an aromatic hydrocarbon, a ketone, an ester, an ether, an alcohol, a phenols and a mixture thereof.

6. A thermoplastic film, printed with the paint of claim 1.

7. An insert molding comprising a thermoplastic film printed on the reverse side with a paint of claim 1 and having on the reverse side a thermoplastic coating layer, said layer applied by an injection backmolding operation.

8. The insert molding of claim 7, wherein the injection backmolded film, the plastic, or both, is a polymethyl methacrylate copolymer.

9. A process for producing insert moldings, comprising
a) screen printing of a thermoplastic film with a paint of claim 1
b) shaping the film,
c) injection backmolding the printed film on the printed side in an injection mold with a thermoplastic, and
d) removing the insert molding from the mold.

10. (Canceled).

11. (Canceled).

12. The paint of claim 1, further consisting essentially of
(d) one or more customary auxiliaries.

13. The paint of claim 2, wherein the binder further comprises polymerized units of
(m4) from 0 to 5% by weight of one or more alkyl acrylates having 1 to 6 carbon atoms in the ester radical.

14. The paint of claim 3, wherein the binder further comprises up to 10% by weight of one or more additional free radically polymerizable comonomers.

15. A cover or device comprising the insert molding of claim 7.

16. The cover or device of claim 15, selected from the group consisting of a backlightable display and a lamp cover.
